(19) United States
(12) Patent Application Publication
(10) Pub. No.: US 2008/0279277 A1
(43) Pub. Date: Nov. 13, 2008

(54) METHODS AND SYSTEMS FOR PERFORMING IMAGE PROCESSING UPON PIXEL DATA AND LOADING PIXEL DATA IN PARALLEL

(76) Inventors: To-Wei Chen, Taoyuan County (TW); Yu-Wen Huang, Taipei City (TW); Chih-Hui Kuo, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/746,631

(22) Filed: May 9, 2007

(51) Int. Cl. H04B 1/66

(52) U.S. Cl. 375/240.15; 375/E07.092

(57) ABSTRACT

A method for performing a specific image processing upon data loaded in a memory unit. The method includes loading non-overlapping pixel data of a second image processing range in a second reference frame into the memory unit, wherein the non-overlapping pixel data are pixel data not within an overlapped area of the first and second image processing ranges; and before the non-overlapping pixel data are completely loaded into the memory unit, start performing the specific image processing upon overlapping pixel data of first and second image processing ranges in a first reference frame.

### BACKGROUND

The invention relates to image processing schemes, and more particularly, to methods and systems for performing motion estimation upon data loaded in a memory unit with high utilization and throughput.

As multimedia technology develops, more and more standards related to video compression have been introduced. For instance, various versions of MPEG standard are developed for digital video compression, and ITU H.264/MPEG-4 AVC by the JVT is the further example.

Video data is actually formed by a continuous series of frames, which are perceived as moving pictures by the human eye. Since the time interval between frames is very short, the difference between neighboring frames is tiny and mostly appears as a change of location of visual objects. Therefore, video coding standards typically eliminate temporal redundancies caused by the similarity between consecutive frames to compress the video data.

In order to eliminate the temporal redundancies mentioned above, a process referred to as motion estimation or motion compensation is employed. Motion estimation or motion compensation relates to determining the redundancy between frames. Before performing motion compensation, a current frame to be processed is typically divided into 16×16-pixel sized macroblocks (MB). For each current macroblock, a most similar prediction block of a reference frame (which can be a preceding frame or a succeeding frame) is then determined by comparing the current macroblock with “candidate” macroblocks of the reference frame. The most similar prediction block is treated as a reference block and the location displacement between the current block and the reference block is then recorded as a motion vector. The above process of obtaining the motion vector is referred to as motion estimation. A commonly employed motion estimation method is block-matching. Because the reference block may not be completely the same as the current block, when using block-matching, it is required to calculate the difference between the current block and the reference block, which is also referred to as a prediction error. The prediction error is encoded as part of the bitstream, then decoded by the decoder. By summing up the reference block (which is available at the decoder side) and the decoded prediction error, the current MB can be reconstructed.

The MPEG standards define three encoding types for encoding frames: intra encoding, predictive encoding, and bi-directional predictive encoding. An intra-coded frame (I frame) is encoded independently without using a reference frame. A predictive encoded frame (P frame) is encoded by referring to a preceding reference frame (I or P frame). In addition, a bi-directionally predictive frame (B frame) is encoded using both a preceding frame and a succeeding frame. In other video compression standards such as H.264, B frames can also be used as reference to decode other frames.

As mentioned above, a frame is composed of a plurality of macroblocks, and is encoded macroblock by macroblock. Each macroblock has a corresponding motion type parameter representing its motion compensation type. FIG. 1 shows a conventional method for performing a block matching operation of motion estimation with a preloading technique. As shown in FIG. 1, a current frame 120 is divided into a plurality of macroblocks. Each macroblock can be of any size. For example, in the MPEG standard, the current frame 120 is typically divided into macroblocks having 16×16 pixels. Each interframe coded macroblock in the current frame 120 is encoded in terms of its pixel-difference and displacement from a macroblock in a previous reconstructed frame 110 (reference frame). During the block matching operation of a first macroblock 100, the first macroblock 100 is compared with same-sized “candidate” macroblocks within a first search range 112 of the previous reconstructed frame 110. The candidate macroblock of the previous reconstructed frame 110 that is determined to have the smallest difference with respect to the first macroblock 100, e.g. a macroblock 113 of the previous reconstructed frame 110, is selected as a reference macroblock. The motion vectors and residues between the reference macroblock 113 and the first macroblock 100 are computed and coded. As a result, the first macroblock 100 can be restored during decompression using the pixel-data of the reference macroblock 113 as well as the motion vectors and residues for the first macroblock 100. In addition, for a second macroblock 122 adjacent to the first macroblock 100, the second macroblock 122 is compared with same-sized “candidate” macroblocks within a second search range 114 of the previous reconstructed frame 110, and the candidate macroblock of the previous reconstructed frame 110 having the smallest difference with respect to the second macroblock 122, e.g. a macroblock 115 of the previous reconstructed frame 110, is selected as a reference macroblock. As shown in FIG. 1, there exists an overlapped area 116 between the first search range 112 and the second search range 114 since the first macroblock 100 and the second macroblock 122 are adjacent to each other.

In general, the previous reconstructed frame 110 is stored in a DRAM and gradually loaded to an SRAM for block matching. Since the first search range 112 and the second search range 114 in the previous reconstructed frame 110 are overlapped, when encoding the second macroblock 122, the pixel data of the overlapped area 116 are already in the SRAM after the block matching operation of the first macroblock 100 is completed. A controller only needs to load pixel data of the second search range 114 beyond the overlapped area 116 from the DRAM to the SRAM for performing the block matching operation of the second macroblock 122.

However, when the conventional method is loading the pixel data of the second search range 114 beyond the overlapped area 116 from the DRAM to the SRAM before performing the block matching operation of the second macroblock 122, the motion estimation unit is idle, resulting in poor utilization and throughput.

### SUMMARY

It is therefore one of the objectives of the present invention to provide methods and systems for performing block matching upon data loaded in a memory unit in an efficient manner.

An embodiment of a method for performing a specific image processing upon data loaded in a memory unit comprises loading non-overlapping pixel data of a second image processing range in a second reference frame into the memory unit, and before the non-overlapping pixel data are completely loaded into the memory unit, start performing the specific image processing upon overlapping pixel data of a second image processing range in a first reference frame. The non-overlapping pixel data are pixel data not overlapped with a first image processing range, whereas the overlapping pixel data are pixel data overlapped with a first image processing range.

In some other embodiments, the next step comprises loading non-overlapping pixel data of the second image processing range in the first reference frame into the memory unit, and before the non-overlapping pixel data of the first reference frame are completely loaded into the memory unit, start performing the specific image processing upon pixel data of the second image processing range in the second reference frame.

In some embodiments, the method further comprising performing the specific image processing upon remaining pixel data of the second image processing range in the first reference frame while preloading pixel data for a subsequent macroblock into the memory unit.

According to an embodiment of the present invention, a system for performing image processing is disclosed. The system comprises a first memory unit storing pixel data of first and second reference frames, a second memory unit, a controller, a memory bus, and a motion estimation unit. The controller loads non-overlapping pixel data of a second image processing range in the second reference frame from the first memory unit into the second memory unit through the memory bus. The non-overlapping pixel data in the second reference frame are pixel data not within an overlapped area of a first image processing range and the second image processing range. The motion estimation unit performs the specific image processing upon overlapped pixel data of first and second image processing ranges in the first reference frame before the non-overlapping pixel data in the second reference frame are completely loaded into the second memory unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a method for performing block matching for motion estimation.

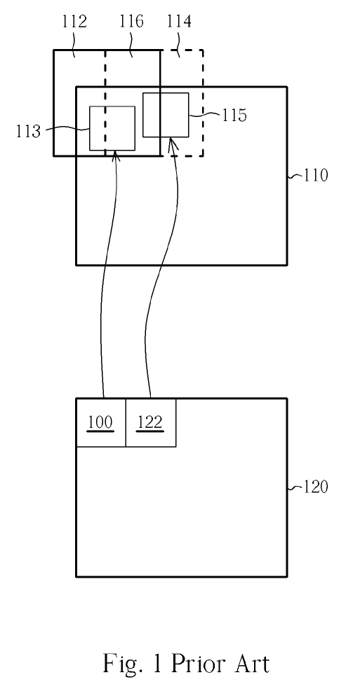

FIG. 2 is a simplified block diagram of an image processing system according to an embodiment of the present invention.

FIG. 3 is a diagram illustrating block matching according to an embodiment of the present invention.

FIG. 4 is a flow chart showing a method for performing a block matching operation according to an embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ” The terms “couple” and “coupled” are intended to mean either an indirect or a direct electrical connection. Thus, if a first device couples to a second device, that connection may be through a direct electrical connection, or through an indirect electrical connection via other devices and connections.

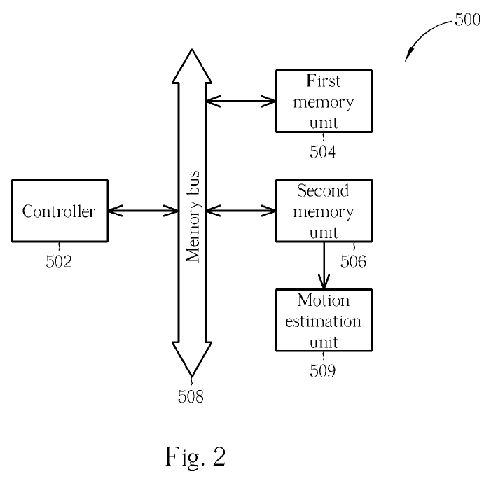

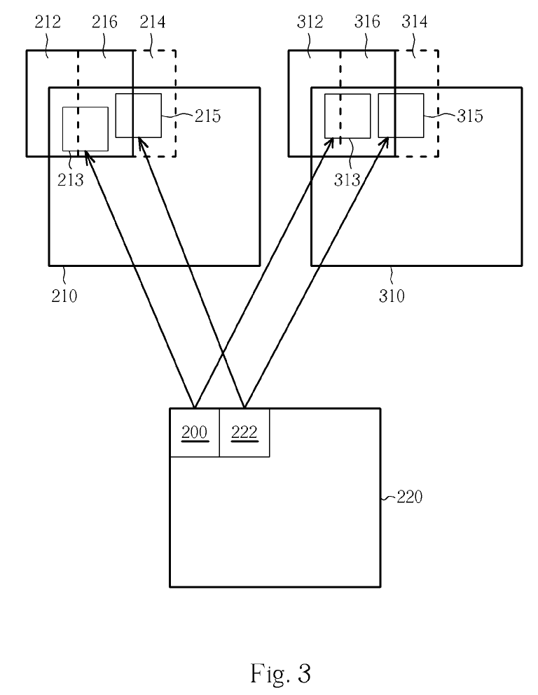

To best explain the present invention systems and methods for performing a block matching operation, please refer to FIG. 2 in conjunction with FIG. 3. FIG. 2 is a simplified block diagram of an image processing system 500 according to an embodiment, and FIG. 3 is a diagram illustrating a block matching operation according to an embodiment. As shown in FIG. 2, the image processing system 500 includes a controller 502, a first memory unit 504, a second memory unit 506, and a motion estimation unit 509, all coupled to a memory bus 508. In this embodiment, the first memory unit 504 is implemented by a DRAM, and the second memory unit 506 is implemented by an SRAM. However, these examples are not meant to be limitations of the present invention.

As shown in FIG. 3, a current frame 220 is divided into a plurality of macroblocks. Each macroblock can be any size. For example, in the MPEG standard, the current frame 220 is typically divided into macroblocks each having 16×16 pixels. Each interframe coded macroblock in the current frame 220 is encoded in terms of its pixel-difference and displacement from a macroblock in a first reference frame 210 and a second reference frame 310. During the block matching operation of the first macroblock 200, the first macroblock 200 is compared with same-sized “candidate” macroblocks within a first search range 212 of the first reference frame 210 and a first search range 312 of the second reference frame 310. Please note that the first search ranges 212 and 312 have the same size and location, except for being applied to different frames. The candidate macroblocks of the first reference frame 210 and the second reference frame 310 that are determined to have the smallest difference with respect to the first macroblock 200, e.g. a macroblock 213 of the first reference frame 210 and a macroblock 313 of the second reference frame 310, are selected as reference macroblocks for the first macroblock 200. The motion vectors and residues between the reference macroblocks 213, 313 and the first macroblock 200 are computed and coded. As a result, the first macroblock 200 can be restored during decompression using the pixel data of the reference macroblocks 213, 313 as well as the motion vectors and residues for the first macroblock 200.

In addition, for a second macroblock 222 adjacent to the first macroblock 200, the second macroblock 222 is compared with same-sized “candidate” macroblocks within a second search range 214 of the first reference frame 210 and a second search range 314 of the second reference frame 310, and the candidate macroblocks of the first reference frame 210 and the second reference frame 310 that are determined to have the smallest difference with respect to the second macroblock 222, e.g. a macroblock 215 of the first reference frame 210 and a macroblock 315 of the second reference frame 310, are selected as reference macroblocks for the second macroblock 222. Please note that there exists an overlapped area 216 between the first search range 212 and the second search range 214, and an overlapped area 316 between the first search range 312 and the second search range 314.

In general, the current frame 220 and the previous reconstructed frames 210, 310 are stored in the first memory unit 504. When the motion estimation unit 509 is processing the first macroblock 200, search ranges 212 and 312 are sequentially loaded from the first memory unit 504 to the second memory unit 506, thus the motion estimation unit 509 can easily access for block matching. Similarly, when the motion estimation unit 509 is processing the second macroblock 222, search ranges 214 and 314 are required to be easily accessed by the motion estimation unit 509. Since search ranges 212 and 214 in the first reference frame 210 are overlapped, and search ranges 312 and 314 in the second reference frame 310 are overlapped, the pixel data of the overlapped areas 216 and 316 are already loaded to the second memory unit 506 and no longer required to be loaded again from the first memory unit 504 when the controller 502 is loading the search ranges for the second macroblock 222.

When the motion estimation unit 509 starts to perform block matching for the second macroblock 222, the controller 502 loads pixel data of the second search range 314 beyond the overlapped area 316 of the second reference frame 310, i.e. the furthest right 16 columns of pixels of the second search range 314, from the first memory unit 504 to the second memory unit 506, and the motion estimation unit 509, in this embodiment, starts performing block matching for the second macroblock 222 upon the pixel data within the overlapped area 216 of the first reference frame 210 at the same time. In other words, before the furthest right 16 columns of pixels of the second search range 214 are loaded into the second memory unit 506, the motion estimation unit 509 is enabled to perform block matching on pixel data of the overlapped area 216 already existed in the second memory unit 506.

The controller 502 then load pixel data of the second search range 214 beyond the overlapped area 216 of the first reference frame 210, i.e. the furthest right 16 columns of pixels of the second search range 214, from the first memory unit 504 to the second memory unit 506, and the motion estimation unit 509 performs block matching upon the pixel data within the second search range 314 of the second reference frame 310. When the motion estimation unit 509 completes block matching for the second reference frame 310, it performs block matching upon the non-overlapping pixel data of the second search range 214. At the same time, the controller 502 may be able to preload data for a subsequent macroblock.

The block matching operations for the following macroblocks obey the data processing flow mentioned above, further description is omitted here for the sake of brevity.

In some embodiments, when the motion estimation unit 509 starts to perform the block matching operation of the second macroblock 222, the controller 502 loads the furthest right 16 columns of pixels of the second search range 214 in the first reference frame 210 from the first memory unit 504 to the second memory unit 506, and the motion estimation unit 509 performs the block matching operation upon the pixel data within the overlapped area 316 of the second reference frame 310 at the same time. In other words, the block matching operation and the data preloading operation are not performed on the same reference frame simultaneously.

The controller 502 loads the furthest right 16 columns of pixels of the second search range 314 in the second reference frame 310 from the first memory unit 504 to the second memory unit 506, and the motion estimation unit 509 performs block matching upon the pixel data within the second search range 214 of the first reference frame 210 at the same time.

Next, the motion estimation unit 509 keeps performing the block matching operation upon the pixel data within the non-overlapping area in the second search range 314 of the second reference frame 310.

In another embodiment, the motion estimation unit 509 performs block matching for the second macroblock upon the overlapping area 216 of the first reference frame 210 while the controller 502 loads the non-overlapping area of the search range 214 of the first reference frame 210. The motion estimation unit 509 then performs block matching upon the non-overlapping area of the search range 214 as well as the overlapping area 316 of the second reference frame while the controller 502 loads the non-overlapping area of the search range 314 of the second reference frame. The motion estimation unit 509 then performs block matching upon the non-overlapping area in the search range 314 of the second reference frame while the controller 502 preloads data for a subsequent macroblock.

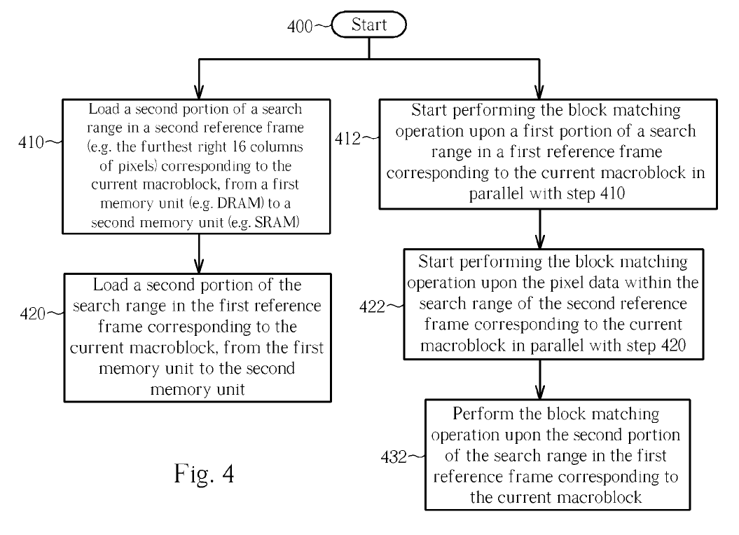

FIG. 4 is a flow chart showing a method for performing a block matching operation according to an embodiment of the present invention. Provided that substantially the same result is achieved, the steps of the process flow chart need not be in the exact order shown and need not be contiguous, that is, other steps can be intermediate. In an exemplary embodiment, the method for processing a current macroblock includes the following steps:
Step 410: Load a second portion of a search range in a second reference frame (e.g. the furthest right 16 columns of pixels) corresponding to the current macroblock, from a first memory unit (e.g. DRAM) to a second memory unit (e.g. SRAM).
Step 412: Start performing the block matching operation upon a first portion of a search range in a first reference frame corresponding to the current macroblock in parallel with step 410.
Step 420: Load a second portion of the search range in the first reference frame corresponding to the current macroblock, from the first memory unit to the second memory unit.
Step 422: Start performing the block matching operation upon the pixel data within the search range of the second reference frame corresponding to the current macroblock in parallel with step 420.
Step 432: Perform the block matching operation upon the second portion of the search range in the first reference frame corresponding to the current macroblock.

Please note that the present invention method can be applied in the block matching operation utilizing multiple reference frames. The embodiments mentioned above that perform the block matching operation utilizing two reference frames are only for illustrative purposes. Additionally, the order of performing the block matching operation upon the reference frames is not limited to the sequence of the reference frames. In the embodiment illustrated by the flowchart of FIG. 4, a search range is divided into two portions, where the first portion is the overlapping area with respect to the search range for the previous macroblock, and the second portion is the remaining pixel data (e.g. the right most 16 columns of pixels) of the search range for the current macroblock. However, in some other embodiments, the first portion of the search range may be further divided into two portions, the motion estimation unit performs block matching on one of the portion while loading the search range of the second reference frame, and after completing block matching upon the second reference frame, the motion estimation unit performs block matching on the other portion of the first portion as well as the second portion of the first reference frame. The same objective of high utilization and throughput is achieved.

The spirit of the present invention method is loading non-overlapping pixel data of a specific search range in a target frame into the memory unit and processing overlapping pixel data that has already been stored in the memory unit at the same time. Regardless of whether the pixel data stored in the memory unit is processed completely, as long as the pixel data stored in the memory unit is processed in parallel with loading of the non-overlapping pixel data of the specific search range in the target frame into the memory unit, this method falls within the scope of the present invention. Therefore, the present invention method can achieve high utilization and throughput in the block matching operation during motion estimation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing a specific image processing upon data loaded in a memory unit, the method comprising:
loading non-overlapping pixel data of a second image processing range in a second reference frame into the memory unit, wherein the non-overlapping pixel data are pixel data not overlapped with a first image processing range in the second reference frame; and
before the non-overlapping pixel data are completely loaded into the memory unit, start performing the specific image processing upon overlapping pixel data of a second image processing range in a first reference frame, wherein the overlapping pixel data are pixel data overlapped with a first image processing range in the first reference frame.

2. The method of claim 1, wherein the specific image processing is a block matching operation, and each of the first and second image processing ranges is a search range for block matching.

3. The method of claim 1, wherein the non-overlapping pixel data are furthest right 16 columns of pixel data of the second image processing range.

4. The method of claim 1, wherein the first image processing ranges in the reference frames correspond to a first macroblock unit in a current frame, and the second image processing ranges in the reference frames correspond to a second macroblock unit next to the first macroblock unit in the current frame.

5. The method of claim 1, further comprising:
loading non-overlapping pixel data of the second image processing range in the first reference frame into the memory unit, wherein the non-overlapping pixel data are pixel data not overlapped with the first image processing range in the first reference frame; and
before the non-overlapping pixel data of the first reference frame are completely loaded into the memory unit, start performing the specific image processing upon pixel data of the second image processing range in the second reference frame.

6. The method of claim 5, further comprising:
performing the specific image processing upon remaining pixel data of the second image processing range in the first reference frame.

7. The method of claim 6, further comprising:
preloading pixel data for a subsequent macroblock of current frame into the memory unit while performing the specific image processing upon the remaining pixel data of the second image processing range in the first reference frame.

8. A system for performing image processing, the system comprising:
a first memory unit, for storing pixel data of first and second reference frames;
a second memory unit, for storing pixel data of image processing ranges loaded from the first memory unit;
a memory bus, coupled to the first memory unit and the second memory unit, for transmitting the pixel data;
a controller, coupled to the memory bus, for loading non-overlapping pixel data of a second image processing range in the second reference frame from the first memory unit into the second memory unit, wherein the non-overlapping pixel data in the second reference frame are pixel data not within an overlapped area of a first image processing range and the second image processing range; and
a motion estimation unit, coupled to the second memory unit, performing the specific image processing upon overlapped pixel data of first and second image processing ranges in the first reference frame before the non-overlapping pixel data in the second reference frame are completely loaded into the second memory unit from the first memory unit.

9. The system of claim 8, wherein when the non-overlapping pixel data in the second reference frame are completely loaded to the second memory unit, the controller loads non-overlapping pixel data of the second image processing range in the first reference frame from the first memory unit into the second memory unit, and the motion estimation unit performs the specific image processing upon the pixel data in the second reference frame.

10. The system of claim 9, wherein the motion estimation unit further performs the specific image processing upon remaining pixel data of the second image processing range in the first reference frame after the non-overlapping pixel data in the first reference frame are loaded to the second memory unit.

11. The method of claim 10, wherein the controller preloads pixel data for a subsequent macroblock of current frame into the memory unit while the motion estimation unit performing the specific image processing upon the remaining pixel data of the second image processing range in the first reference frame.

12. The system of claim 8, wherein the first memory unit is a DRAM.

13. The system of claim 8, wherein the second memory unit is an SRAM.
